(19) United States
(12) Patent Application Publication
(10) Pub. No.: US 2010/0209533 A1
(43) Pub. Date: Aug. 19, 2010

(54) CHEMICAL COMPOSITION FOR USE AS A DISINFECTANT

(76) Inventors: Jenny Stepp, Newhall, CA (US); Jim Stepp, Newhall, CA (US); Saverio Persico, Canyon County, CA (US)

Correspondence Address: Walter J. Tencza Jr., Suite 210, 100 Menlo Park, Edison, NJ, 08837, US

(21) Appl. No.: 12/388,537

(22) Filed: Feb. 19, 2009

(51) Int. Cl. A01N 59/00; A01P 1/00

(52) U.S. Cl. 424/616

(57) ABSTRACT

A chemical composition is disclosed for a disinfectant, which is particularly usefully for disinfecting toothbrushes and other oral and/or dental products. One or more chemical compositions may be applied to an object, such as the bristles of a toothbrush with a portable spray container.

### FIELD

This invention relates to improved methods and apparatus concerning disinfectants, particularly disinfectants for toothbrushes.

### BACKGROUND

The importance of disinfecting objects, and in particular dental or oral objects, such as toothbrushes, is known. Concerning toothbrushes specifically, as early as 1920 it was known that toothbrushes could be a source of repeated oral infections.

There are various disinfectants known in the art, including disinfectants for toothbrushes. For example, there are known ultra violet (UV) devices and steam devices which are used for toothbrush cleansing. UV devices are only effective when the UV light is directly on toothbrush bristles. If part of the bristles are not directly in line of the UV light, the cleaning process is incomplete. Some UV units require toothbrush bristles to face downward causing the brush to be submerged in contaminated water. However, the combination of heat from the UV bulb and the pressure of the brush resting on its head cause the bristles to harden, therefore increasing the risk of gum damage.

Steam devices have major drawbacks, including messiness, and the inconvenience of not knowing whether the steam devices have reached their proper temperature to sterilize. Some steam devices can only use distilled water. There are one hundred and eight pathogens known to survive distillation, let alone steam. The steam devices are also expensive and not portable.

In general, the UV devices and steam devices, are expensive, some costing over one hundred dollars currently, and these devices may need to be operated for fifteen minutes or longer in order to sanitize a toothbrush.

There is a known disinfectant which has a product name “Spray It Clean”, whose main ingredient is ethyl alcohol and which also contains thymol and eucalyptus. These ingredients are also used in a mouthwash called Listerine (trademarked). The “Spray It Clean” product is used for disinfecting toothbrushes.

### SUMMARY

The present disclosed technology in one or more embodiments provides a chemical composition for a disinfectant, which is particularly useful for disinfecting toothbrushes and other oral and/or dental products. One or more chemical compositions in accordance with one or more embodiments of the disclosed technology may be applied with a portable spray container, which requires no electric cords, replacement bulbs, batteries, distilled water, bulky units or other parts which may have been associated with prior art disinfecting devices.

A method is disclosed in one embodiment which includes preparing a chemical composition, and applying the chemical composition to an object to disinfect the object. The chemical may be comprised of water, hydrogen peroxide, eucalyptus oil, clove oil, peppermint oil, and sodium benzoate. The chemical composition may be further comprised of glycerin.

### BRIEF DESCRIPTION OF THE DRAWINGS

FIG. 1 shows a flow chart of a method in accordance with an embodiment of the present disclosed technology; and

FIG. 2 shows a simplified diagram of a container which can be used in accordance with the method of FIG. 1.

### DETAILED DESCRIPTION OF THE DRAWINGS

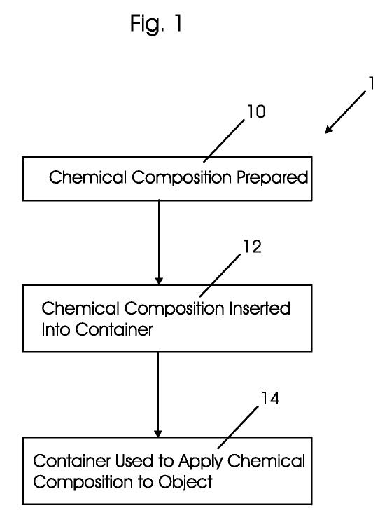

FIG. 1 shows a flow chart 1 of a method in accordance with an embodiment of the present disclosed technology. At step 10, a chemical composition is prepared. The chemical composition, in one embodiment may be called chemical composition A, and may have the chemical composition of 95.789% (percent) R.O. water (i.e. water that has been purified through R.O. which stands for “reverse osmosis”), 3.0% (percent) cosmetic grade hydrogen peroxide, 0.003% (percent) eucalyptus oil, 0.005% (percent) clove oil, 0.003% peppermint oil, 1.1% (percent) glycerin, and 0.1% (percent) sodium benzoate. Sodium benzoate is a natural preservative.

Some ingredients may be in a range of +/−2%. For example, the R.O. water may be in the range of 93.789%-97.789%, the cosmetic grade hydrogen peroxide can range from 2.5%-3% and in a preferred embodiment cannot exceed 3%. Eucalyptus oil can range from 0.002%-0.0035%; Clove Oil can range from 0.003%-0.006%; Peppermint Oil can range from 0.002%-0.005%; Glycerin can range from 0.0%-1.3%; Sodium Benzoate should remain at approximately 0.1% in a preferred embodiment

Although glycerin is used in a preferred embodiment, glycerin can be eliminated from the chemical composition in accordance with other embodiments of the present invention. The ingredients or components of the chemical composition A, of a modified chemical composition within the percentage ranges specified, or of a modified chemical composition without glycerin, work together to provide unexpected results.

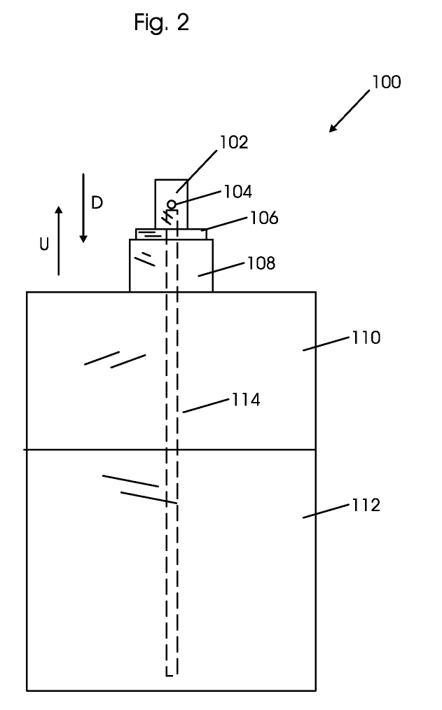

At step 12 the chemical composition, such as chemical composition A, is inserted into a container, such as a container 100 shown in simplified form in FIG. 2. Steps 10 and 12 may occur at the same time or in any order. For example, the different components of the chemical composition may be mixed, formed, and/or combined together in the container, such as container 100. The container 100 includes a spray portion or nozzle 102 having an opening 104. The container 100 includes a container body 110 which contains the chemical composition 112 which may be in a liquid form. The container 100 also includes portions 108, and 106 which keep the nozzle 102 in place.

The container 100 also includes a tube 114 shown in dashed lines. In operation, the nozzle 102 is pushed down in the direction D causing the chemical composition 112 to come up in the direction U through the tube 114 and out the opening 104 (in a direction substantially parallel to D and U) of the nozzle 102. Any type of container can be used for applying the chemical composition 112 however a sprayer is preferred in certain embodiments of the disclosed technology, because a sprayer will give the consumer better coverage and spray emits oxygen into the air causing a “green” (environmentally friendly result).

The container is preferably made completely out of polyethylene (PET) plastic and in one embodiment is dark in color, due to the properties of the cosmetic grade hydrogen peroxide. The bottle material will reduce the concentration of metal ion catalysts in the hydrogen peroxide. Dark colored plastic bottles limit wavelengths of light that can be absorbed by the solution, therefore restricting the initiation of the disproportionate reaction. Also PET plastic is preferred for recycling.

In one or more embodiments of the present disclosed technology, the chemical composition, such as 112, is an all natural liquid disinfectant which is preferably applied from a spray container. The chemical composition 112, when it has a chemical composition A as previously disclosed, eliminates 99.9% of all microorganisms on contact. Chemical composition A is a user-friendly environmentally safe product that benefits the environment through the emission of hydrogen peroxide. Hydrogen peroxide is purified liquid oxygen and its purity is enhanced by the properties of Eucalyptus and Clove Oils.

The chemical composition 112, such as chemical composition A, is preferably used for toothbrush purification. The chemical composition 112, such as chemical composition A, can be sprayed on a toothbrush both before and after the toothbrush is used to sanitize and/or disinfect the toothbrush. The chemical composition 112, such as chemical composition A, can also be used to sanitize and/or disinfect other dental or oral products such as dentures, retainers, mouth guards, gum stimulators, picks, and floss brushes. The chemical composition 112 can also be used to sanitize and/or disinfect other objects that an individual might touch with his/her hand or hands, such as combs, hairbrushes, toilet seats, diaper stations, door handles, cell phones, public telephones, computer mouses, computer keyboards, desktops, utensils, tabletops, shopping cart handles, and remote controls devices such as television remote control devices. For some of these uses, such as for cell phones, public telephones, computer mouses, computer keyboards, desktops, shopping cart handles, and remote controls devices the chemical composition 112, such as chemical composition A, may be sprayed onto a material, such as a cloth, paper towel, or tissue, and then used to wipe the particular object.

For a toothbrush sanitizing application, in one embodiment, one to two sprays of the chemical composition 112, such as chemical composition A, are applied to the bristles of a toothbrush before an individual has used the toothbrush for brushing their teeth. The application of chemical composition A by spraying one to two times before brushing can kill 99.9% of the harmful bacteria causing germs that can potentially affect an entire household.

The use of chemical composition 112, such as chemical composition A, promotes good dental health, stronger gums, fresher breath, and in one embodiment, the cosmetic grade hydrogen peroxide base will enhance and assist in keeping teeth their whitest.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising the steps of:
preparing a chemical composition;
applying the chemical composition to an object to disinfect the object; and
wherein the chemical composition is comprised of water, hydrogen peroxide, eucalyptus oil, clove oil, peppermint oil, and sodium benzoate.

2. The method of claim 1 wherein
wherein the chemical composition is further comprised of glycerin.

3. The method of claim 1 wherein
the water is purified through reverse osmosis.

4. The method of claim 1 wherein
the water ranges from is 93.789% to 97.789% of the chemical composition;
the hydrogen peroxide ranges from 2.5%-3%, but does not exceed 3% of the chemical composition;
the eucalyptus oil ranges from 0.002%-0.0035% of the chemical composition;
the clove oil ranges from 0.003%-0.006% of the chemical composition;
the peppermint oil ranges from 0.002%-0.005% of the chemical composition; and
the sodium benzoate is approximately 0.1% of the chemical composition.

5. The method of claim 4 wherein
wherein the chemical composition is further comprised of glycerin, and the glycerin ranges from 0.0% to 1.3% of the chemical composition.

6. The method of claim 1 further comprising
inserting the chemical composition into a container after the chemical composition is prepared and prior to applying the chemical composition to the object; and
and using the container to apply the chemical composition to the object.

7. The method of claim 6 wherein
the container is substantially made out of polyethylene terephthalate.

8. The method of claim 1 wherein
the object is a dental product.

9. The method of claim 8 wherein
the object is a tooth brush.
